(19) United States
(12) Patent Application Publication
(10) Pub. No.: US 2026/0285440 A1
(43) Pub. Date: Sep. 24, 2026

(54) ROTATING-BODY SUPPORT UNIT AND BICYCLE

(71) Applicant: YAMAHA HATSUDOKI KABUSHIKI KAISHA, Iwata-shi (JP)

(72) Inventor: Tomohiro USAMI, Shizuoka (JP)

(21) Appl. No.: 19/570,336

(22) Filed: Mar. 18, 2026

(30) Foreign Application Priority Data
Mar. 19, 2025 (JP) 2025-045819

(51) Int. Cl. B62M 3/00

(52) U.S. Cl. CPC B62M 3/003

(57) ABSTRACT

A rotating body support unit is mountable on a frame of a bicycle and includes a housing separate from the frame, a rotating body at least partially located within the housing, a bearing to rotatably support the rotating body, and a case detachably mounted to an outside of the housing along an axial direction of the rotating body to support the bearing. The bearing includes an outer ring, an inner ring, and rollers. The outer ring is mounted on the case and the inner ring is mounted on the rotating body. The rotating body is a crankshaft of the bicycle or a rotational component with the same center of rotation as the crankshaft.

### CROSS-REFERENCE TO RELATED APPLICATION

This application is based upon and claims the benefit of priority to Japanese Patent Application No. 2025-45819, filed on Mar. 19, 2025, the entire contents of which are hereby incorporated herein by reference.

### BACKGROUND OF THE INVENTION

### 1. Field of the Invention

The present invention relates to rotating body support units mounted on frames of bicycles.

### 2. Description of the Related Art

A bicycle may include a rotating body support unit mounted on its frame to support rotating bodies such as a crankshaft or a motor output shaft. An example of such a rotating body support unit is a drive unit mounted on the frame of an electric motor-assisted bicycle. For example, the drive unit supports the crankshaft and includes a motor that provides a driving force to propel the bicycle. In such a drive unit, the housing that contains the motor is provided with bearings that rotatably support the crankshaft.

For example, JP 2023-051374 A discloses a drive unit for a human-powered vehicle including a housing formed as a part separate from the frame of the human-powered vehicle, a crankshaft that extends through the housing, and a motor. The housing includes bearings that rotatably support the crankshaft and a member that fixes the bearings in position along the axial direction of the crankshaft.

JP 2019-031257 A discloses a drive unit mounted on the vehicle body frame of an electric motor-assisted bicycle. The drive unit includes a housing, a motor, a crankshaft, and a pair of bearings that rotatably support the crankshaft. The drive unit has a movement-limiting structure that limits movement of one of the bearings, i.e., first bearing, along the axial direction of the crankshaft. The movement-limiting structure includes an abutting portion of the housing that abuts the outer end surface, along the left-right direction of the vehicle, of the outer ring of the first bearing, and an abutting portion of a plate member that abuts the inner end surface of the outer ring.

When a bearing supporting the crankshaft of a drive unit of a conventional construction is to be replaced, the drive unit must be removed from the frame of the bicycle and disassembled. This makes it difficult for an end user of the bicycle to replace a bearing of the drive unit.

### SUMMARY OF THE INVENTION

In view of the above-described problem, example embodiments of the present invention provide rotating body support units and bicycles that facilitate replacement of bearings.

A rotating body support unit according to an example embodiment of the present invention is mountable on a frame of a bicycle, and includes a housing mountable on the frame, a rotating body at least partially located within the housing, a bearing to rotatably support the rotating body, and a case detachably mounted to an outside of the housing along an axial direction of the rotating body to support the bearing.

The bearing includes an outer ring, an inner ring, and rollers between the outer ring and the inner ring, wherein the outer ring is mounted on the case and the inner ring is mounted on the rotating body.

The rotating body is a crankshaft of the bicycle or a rotational component with the same center of rotation as the crankshaft.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a left side view of a bicycle according to an example embodiment of the present invention.

FIG. 2 shows a perspective view and an exploded perspective view of a rotating body support unit as viewed from the right.

FIG. 3 shows a perspective view and an exploded perspective view of the rotating body support unit as viewed from the left.

FIG. 4 is a cross-sectional view of the rotating body support unit.

FIG. 5 is an enlarged view of the second bearing and surrounding areas of FIG. 4.

FIG. 6 is an enlarged view of the first bearing and surrounding areas of FIG. 4.

FIG. 7 shows a variation of the first bearing and surrounding areas of FIG. 6.

FIG. 8 shows a variation of the first bearing and surrounding areas of FIG. 6.

FIG. 9 is a cross-sectional view of a variation of the rotating body support unit.

FIG. 10 is an enlarged view of the bearing and surrounding areas of FIG. 9.

FIG. 11 is a cross-sectional view showing a variation of a seal.

FIG. 12 is a cross-sectional view of a variation of the rotating body support unit.

### DETAILED DESCRIPTION OF THE EXAMPLE EMBODIMENTS

Rotating body support units according to example embodiments of the present invention are mountable on frames of bicycles.

A rotating body support unit according to an example embodiment of the present invention includes a housing mountable on the frame, a rotating body at least partially located within the housing, a bearing to rotatably support the rotating body, and a case detachably mounted to an outside of the housing along an axial direction of the rotating body to support the bearing.

The bearing includes an outer ring, an inner ring, and rollers between the outer ring and the inner ring, wherein the outer ring is mounted on the case and the inner ring is mounted on the rotating body.

The rotating body is a crankshaft of the bicycle or a rotational component with the same center of rotation as the crankshaft.

According to an example embodiment of the present invention, the rotating body rotatably supported by the bearing supported by the case includes the crankshaft or a rotational component coaxial therewith. Such a rotating body receives high loads and a bearing supporting the rotating body tends to be frequently replaced. Further, the bearing is located between the rotating body and a case that is detachably mounted on the housing while being outside thereof along the axial direction of the rotating body. Thus, by removing the case from the housing in the axial direction of the rotating body, the bearing for the crankshaft or rotational component can be removed. This enables removing and mounting a bearing without removing the housing of the rotating body support unit from the frame of the bicycle. In other words, replacement of a bearing, which tends to be frequently replaced, is facilitated.

The case may include a tubular portion concentric with the rotating body to allow the rotating body to be inserted therethrough. The outer ring of the bearing is mounted on the inner circumferential surface of the tubular portion. The inner ring of the bearing is mounted on the outer circumferential surface of the rotating body.

For example, the rotating body outputs a driving force that propels the bicycle. In example embodiments where the bearing supported by a case supports only one rotating body, the rotating body is the crankshaft of the bicycle or a rotational component with the same center of rotation as the crankshaft. In example embodiments where the bearing supported by a case supports a plurality of rotating bodies, one of the rotating bodies is the crankshaft of the bicycle or a rotational component with the same center of rotation as the crankshaft. The rotational component is supported by the bearing so as to be rotatable about the same center of rotation as the crankshaft. The axial direction of the rotating body/bodies corresponds to the direction of extension of the centerline of rotation (i.e., axial center or axis of rotation) of the rotating body/bodies supported by the bearing.

The rotating body supported by the bearing supported by the case may be a rotating body extending through the case. In such example embodiments, the rotating body, while extending through the case, is rotatably supported. Specifically, the rotating body is supported with a portion of the rotating body protruding outside the space defined by the case and the housing. Such a rotating body receives high loads and a bearing supporting the rotating body tends to be frequently replaced. Thus, replacement of a bearing, which tends to be frequently replaced, is facilitated. It is to be noted that the arrangement where the rotating body extends through the case may also be applied to example embodiments where the rotating body supported by the bearing supported by the case is neither the crankshaft nor a rotational component coaxial thereto.

According to an example embodiment of the present invention, the case may be mounted on the housing using a fastener. Thus, the case may be removed from the housing by removing the fastener. The fastener may be a bolt, for example. The direction in which the fastener is inserted may be the same as the axial direction of the rotating body, for example.

According to an example embodiment of the present invention, the case and the housing may include a position-fixing structure configured to fix the case in position relative to the housing. This allows the case to be fixed in position relative to the housing.

For example, the position-fixing structure may include a position-fixing projection on one of the case and the housing and a position-fixing recess on the other one of the case and the housing. The position-fixing projection is inserted into the position-fixing recess in the axial direction of the rotating body. The position-fixing projection, having been inserted into the position-fixing recess, is engaged with the position-fixing recess so as not to move in a direction perpendicular to the axial direction of the rotating body. The position-fixing structure may have a spigot structure, or may include two or more position-fixing pins as well as holes that allow the pins to be inserted therein.

According to an example embodiment of the present invention, the case and the housing may be configured such that the case is mounted on the housing by joining a first thread on the case and a second thread on the housing. One of the first and second threads is a male thread, and the other one of the first and second threads is a female thread.

For example, the case may include a tubular portion coaxial with the rotating body, where the first thread is on the tubular portion. In such example embodiments, the housing includes a tubular portion of the housing corresponding to the tubular portion of the case, where the second thread is on the tubular portion of the housing. The tubular portion of the case and the tubular portion of the housing are coaxial. For example, the first thread, a male thread, may be on the outer circumference of the tubular portion of the case, and the second thread, a female thread, may be on the inner circumference of the tubular portion of the housing. Alternatively, the first thread, a female thread, may be on the inner circumference of the tubular portion of the case, and the second thread, a male thread, may be provided on the outer circumference of the tubular portion of the housing.

According to an example embodiment of the present invention, the outer ring of the bearing may be press-fitted into the case. This facilitates removal of the bearing compared with example embodiments where the inner ring of the bearing is press-fitted onto the rotating body. It is to be noted that this may also be applied to example embodiments where the rotating body supported by the bearing supported by the case is neither the crankshaft nor a rotational component coaxial thereto.

Example embodiments where the outer ring of the bearing is press-fitted into the case include, for example, example embodiments where the outer ring is designed such that the diameter of its outer circumference is slightly larger than the diameter of the hole in the case into which the outer ring is to be inserted and the outer ring is fitted into the hole in the case by an interference fit.

In example embodiments where the outer ring of the bearing is press-fitted on the case, the inner ring of the bearing may be mounted on the rotating body without being press-fitted. In such example embodiments, for example, the rotating body is mounted on the inner ring of the bearing by a clearance fit or transition fit.

According to an example embodiment of the present invention, the bearing may include a first bearing and a second bearing spaced apart in the axial direction of the rotating body. The case may include a first case to support the first bearing and mountable to and detachable from a first side of the housing along the axial direction of the rotating body, and a second case to support the second bearing and mountable to and detachable from a second side of the housing along the axial direction of the rotating body. This facilitates replacement of both bearings that support the rotating body. It is to be noted this may also be applied to example embodiments where the rotating body supported by the bearings supported by the cases is neither the crankshaft nor a rotational component coaxial therewith.

According to an example embodiment of the present invention, the rotating body support unit may further include an outer-ring retainer to support an inner surface or an outer surface, along the axial direction of the outer ring, of the bearing, the outer-ring retainer being integrally attached or unitary with the case or the housing. The outer-ring retainer limits axial movement of the bearing relative to the housing. This limits axial movement of the rotating body relative to the housing.

The outer-ring retainer may be in contact with the surface of the outer ring to support it, or may support the surface of the outer ring by another member.

For example, the outer-ring retainer may be a retaining ring mounted on a groove provided on the inner circumferential surface of the case or housing such that a portion thereof protrudes from the groove. In such example embodiments, the portion of the retaining ring that protrudes from the groove supports the surface of the outer ring. The retaining ring is also sometimes referred to as circlip or snap ring, for example.

The outer-ring retainer may also be a portion of the housing or case that protrudes radially inwardly from the inner circumferential surface of the hole that allows the outer ring to be inserted therein (i.e., tubular portion that allows the rotating body to be inserted therein).

The outer-ring retainer may include an inner outer-ring retainer to support the inner surface of the bearing along the axial direction, and an outer outer-ring retainer to support the outer surface of the bearing along the axial direction. This further limits axial movement of the bearing. In such example embodiments, one of the inner outer-ring retainer and the outer outer-ring retainer may be a retaining ring mounted on the groove on the inner circumferential surface of the case or housing such that a portion thereof protrudes from the groove, and the other one may be a portion of the housing or case that protrudes radially inwardly from the inner circumferential surface of the hole that allows the outer ring to be inserted therein.

According to an example embodiment of the present invention, the rotating body support unit may further include an inner-ring support to support an outer surface, along the axial direction, of the inner ring of the bearing, the inner-ring support being mounted on the rotating body. The inner-ring support limits axial movement of the bearing relative to the rotating body.

The inner-ring support may be a spacer provided between the bearing and an external member mounted on the rotating body and located axially outward of the bearing (e.g., sprocket, crank arm, or outer inner-ring retainer). The inner-ring support may be in contact with the surface of the inner ring to support it, or may support the surface of the inner ring by another member.

According to an example embodiment of the present invention, the rotating body support unit may further include an outer inner-ring retainer to support the outer surface, along the axial direction, of the inner-ring support, the outer inner-ring retainer being mounted on the rotating body. This limits axial movement of the bearing relative to the rotating body. For example, the outer inner-ring retainer may be a retaining ring mounted on a groove on the outer circumferential surface of the rotating body such that a portion thereof protrudes from the groove. The outer inner-ring retainer may be in contact with the outer surface, along the axial direction, of the inner ring to support it, or may support this surface by another member. In example embodiments where the inner-ring support is omitted, the outer inner-ring retainer is configured to support the outer surface of the inner ring.

According to an example embodiment of the present invention, the rotating body support unit may further include an inner inner-ring retainer to support the inner surface, along the axial direction, of the inner ring, the inner inner-ring retainer being mounted on the rotational component. For example, the inner inner-ring retainer may be a retaining ring mounted on a groove on the outer circumferential surface of the rotating body such that a portion thereof protrudes from the groove. Alternatively, the inner inner-ring retainer may be a portion of the rotating body that protrudes radially outwardly from the rotating body. It is to be noted that the inner inner-ring retainer may be in contact with the inner surface, along the axial direction, of the inner ring to support it, or may support this surface by another member.

According to an example embodiment of the present invention, the rotating body support unit may further include a seal located axially outward of the bearing to seal a gap between the case and the inner-ring support. The seal protects the bearing from water, mud, and dust, for example.

The seal may be mounted on the inner-ring support to be slidable on the case. Alternatively, the seal may be mounted on the case to be slidable on the inner-ring support.

According to an example embodiment of the present invention, an axial dimension of the case may be longer than an axial dimension of the bearing. This improves the bearing strength and the degree of freedom regarding the support position of the bearing relative to the case.

For example, the axial dimension of the inner circumferential surface of the tubular portion of the case may be longer than the axial dimension of the outer ring of the bearing. In other words, the axial dimension of the inner circumferential surface of the hole in the case that allows the outer ring of the bearing to be inserted may be longer than the axial dimension of the outer ring.

For example, the outer ring of the bearing may be mounted on the case at such a position that the entire outer ring of the bearing is contained in the hole in the case along the axial direction.

According to an example embodiment of the present invention, a case may support a plurality of bearings and the plurality of bearings supported by the case may support a plurality of respective rotating bodies. In such example embodiments, one of the rotating bodies supported by the case using the plurality of bearings is the crankshaft or a rotational component coaxial therewith, and another rotating body is a rotating body with a centerline (axis) of rotation different from that of the crankshaft. The direction of the centerline (axis) of rotation of the other rotating body may be the same as the direction of the centerline (axis) of rotation of the crankshaft, and the centerline (axis) of rotation of the other rotating body may be spaced apart from the centerline (axis) of rotation of the crankshaft.

An example embodiment of the present invention includes a bicycle including the rotating body support unit according to any one of the example embodiments described above.

According to an example embodiment of the present invention, the bicycle may include, for example, a frame, a vehicle wheel rotatably supported by the frame, and a transmission to transmit a driving force from the crankshaft to the vehicle wheel.

For example, the rotating body support unit is configured to support the rotating body, e.g., the crankshaft. In such example embodiments, the rotating body support unit may be a drive unit including a motor. The rotating body support unit may include a transmission to transmit the driving force from the motor to the crankshaft.

Alternatively, the rotating body support unit may support the crankshaft, and include a torque sensor to detect a rotational torque of the crankshaft.

Alternatively, the rotating body support unit may include a motor and may be configured to support the rotating body which may be the output shaft of the motor. The driving force from the output shaft of the motor may be transmitted to the vehicle wheel by the transmission. Alternatively, the rotating body support unit may include a speed change mechanism and may be configured to support a rotating body in the speed change mechanism.

Now, a bicycle and a rotating body support unit according to example embodiments of the present invention will be described with reference to the drawings. In the drawings, the same or corresponding elements are labeled with the same reference numerals, and their description will not be repeated. The sizes of the components in the drawings do not exactly represent the sizes of actual components or the size ratios of various components, for example. In the description provided below, “front/forward” and “rear(ward)”, “left” and “right”, and “top/up(ward)” and “bottom/down(ward)” of a bicycle refer to such directions as perceived by a rider on the bicycle. The directions “front/forward” and “rear(ward)”, “left” and “right”, and “top/up(ward)” and “bottom/down(ward)” of the bicycle are the same as the respective directions of the frame of the bicycle and the rotating body support unit mounted on the bicycle. Furthermore, the forward direction of the bicycle is aligned with the front-rear direction of the bicycle. The signs “F”, “B”, “U”, “D”, “R” and “L” in the drawings refer to “forward”, “backward (i.e., rearward)”, “upward”, “downward”, “right”, and “left”, respectively.

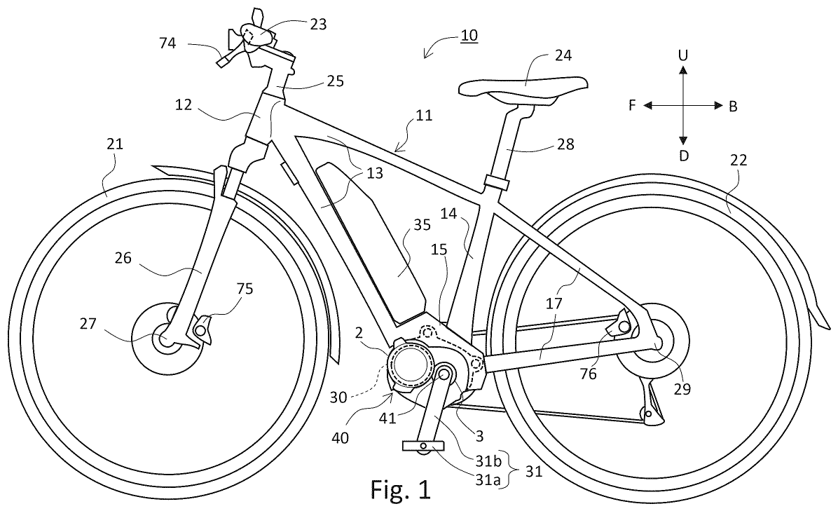

FIG. 1 is a left side view of a bicycle 10 including a rotating body support unit 40 mounted thereon according to an example embodiment of the present invention. By way of example, the bicycle 10 shown in FIG. 1 is an electric motor-assisted bicycle. By way of example, the rotating body support unit 40 is a drive unit.

The bicycle 10 includes a frame 11, a plurality of vehicle wheels 21 and 22, a crankshaft 41, a transmission to transmit a driving force from the crankshaft 41 to at least one of the vehicle wheels, and the rotating body support unit 40 mounted on the frame 11. The rotating body support unit 40 includes a housing 2 mounted on the frame 11, a rotating body, a bearing that rotatably supports the rotating body, and a case 3 that supports the bearing. In the present example embodiment, the rotating body is the crankshaft or a rotational component coaxial therewith.

The crankshaft 41 receives a pedaling force. The two ends of the crankshaft 41 along the left-right direction each have a pedal 31 mounted thereon. Each pedal 31 includes a crank arm 31b and a step 31a. Specifically, the two ends of the crankshaft 41 each have a crank arm 31b mounted thereon. For each crank arm 31b, a pedal step 31a is mounted on its distal end. As the user presses the pedals 31, the crankshaft 41 rotates.

Rotation of the crankshaft 41 is transmitted to the vehicle wheel 22 via the transmission. The transmission may include, for example, a first sprocket that rotates together with the crankshaft 41, a second sprocket that rotates together with the vehicle wheel 22, and a chain that engages with the first and second sprockets. In such example embodiments, the transmission may include a one-way clutch (or one-way clutches) located between the crankshaft 41 and first sprocket and/or between the second sprocket and vehicle wheel 22. Alternatively, the transmission may include a first gear that rotates together with the crankshaft 41, a second gear that rotates together with the vehicle wheel 22, and a shaft. The ends of the shaft have respective toothed wheels that engage with the first and second gears, respectively. In such example embodiments, the transmission may include a one-way clutch (or one-way clutches) located between the crankshaft 41 and first gear and/or between the second gear and vehicle wheel 22.

The frame 11 includes a head pipe 12, a front frame portion 13, a seat frame portion 14, and rear frame portions 17. The front frame portion 13 is coupled to the head pipe 12 and extends rearward from the head pipe. The seat frame portion 14 is located between the front and rear frame portions 13 and 17 to support a seat 24. The rear frame portions 17 rotatably support the vehicle wheel 22 (i.e., rear wheel 22). A handle stem (i.e., steering column) 25 is inserted into the head pipe 12 so as to be rotatable. Handlebars 23 are fixed to the upper end of the handle stem 25. A front fork 26 is fixed to the lower end of the handle stem 25. The front fork 26 rotatably supports the vehicle wheel 21 (i.e., front wheel 21). In the example embodiment of FIG. 1, the front frame portion 13 includes two tubes, i.e., an upper tube and a lower tube, in other example embodiments, the front frame portion 13 may include only one tube.

The rotating body support unit 40 is mounted on a bracket 15 of the frame 11. The bracket is coupled to at least one of the front frame portion 13, the seat frame portion 14 or a rear frame portion 17. In the example embodiment of FIG. 1, the bracket 15 is coupled to the front frame portion 13, the seat frame portion 14, and the rear frame portion 17. Alternatively, the rotating body support unit 40 may be directly attached to the frame 11 without using a bracket. The housing 2 of the rotating body support unit 40 is a part separate from the frame 11. The housing 2 is mounted on the frame 11 using fasteners, for example.

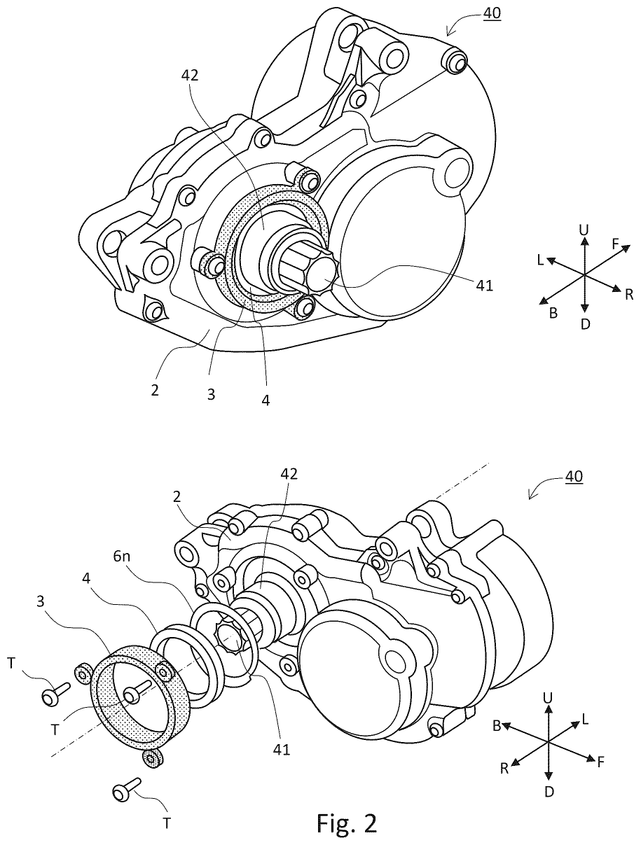

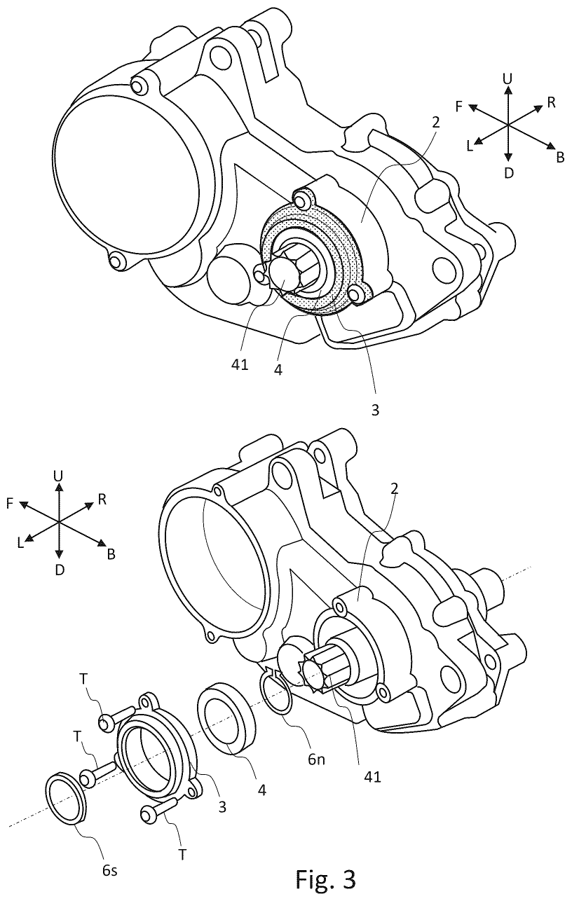

FIG. 2 shows a perspective view and an exploded perspective view of the rotating body support unit 40 as viewed from the right. FIG. 3 shows a perspective view and an exploded perspective view of the rotating body support unit 40 as viewed from the left. In this exemplary example embodiment, the rotating body support unit rotatably supports the crankshaft 41 and a rotational component 42, by bearings 4. The rotational component 42 is coaxial with the crankshaft 41 and rotates together with the crankshaft 41. The crankshaft 41 and rotational component 42 are examples of rotating bodies. The rotating body/bodies is/are rotatably supported on the cases 3 by the bearings 4. The rotating body/bodies extend(s) through the cases 3. In the example embodiment of FIGS. 2 and 3, the crankshaft 41 and rotational component 42 extend through the housing 2. In other words, portions of the crankshaft 41 that include both ends along the axial direction protrude outside the housing 2, and so does a portion of the rotational component 42 that includes one end along the axial direction. The rotational component 42 includes a tubular body through which the crankshaft 41 extends. The rotational component 42 includes a portion contained within the housing 2 and a portion that protrudes outside the housing 2. The rotating body/bodies (in the present example embodiment, the crankshaft 41 and rotational component 42) extend through the cases 3 and, in that state, is/are rotatably supported by the cases 3.

Each case 3 is separate from the housing 2. The case 3 is detachable from and mountable on the housing 2 while being outside thereof along the axial direction of the rotating body/bodies (in the present example embodiment, the axial direction of the crankshaft 41 and rotational component 42). Specifically, the case 3 may be mounted on the housing 2 from the outside toward the inside along the axial direction, and removed toward the outside along the axial direction. In other words, the case 3 may be mountable to and detachable from one side of the housing along the axial direction of the rotating body/bodies. In the example embodiment of FIGS. 2 and 3, each case is mounted on the housing 2 using fasteners T. In the present example embodiment, the direction in which the fasteners T are inserted is aligned with the axial direction of the rotating body/bodies. The case 3 is preferably fastened to the housing 2 using two or more fasteners T. A fastener T is, for example, a screw such as a bolt. The case 3 supports the associated bearing 4. The bearing 4 rotatably supports the rotating body/bodies (in the present example embodiment, the crankshaft 41 and rotational component 42). The bearing 4 includes an outer ring, an inner ring, and rollers. The outer ring is mounted on the case 3. The inner ring is mounted on the rotating body/bodies (in the present example embodiment, crankshaft 41 and rotational component 42).

In the example embodiment of FIGS. 2 and 3, each bearing 4 is positioned between the associated case 3 and crankshaft 41 and between the case 3 and rotational component 42. Thus, the bearing 4 may be removed from the rotating body support unit 40 by removing the case 3 from the housing 2. This enables removal and mounting of the bearing 4 without removing the housing 2 of the rotating body support unit 40 from the frame 11 of the bicycle 10. This facilitates replacement of the bearing 4.

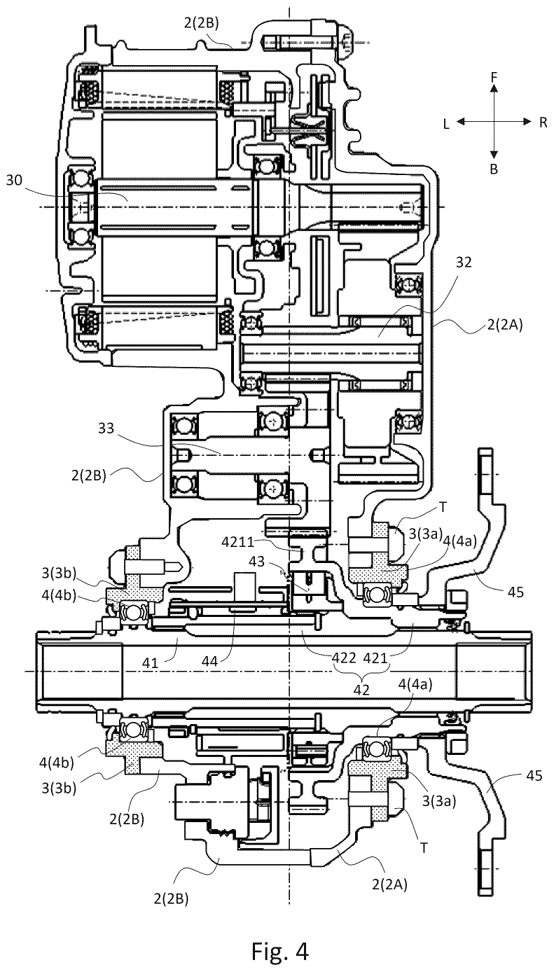

FIG. 4 is a cross-sectional view of the rotating body support unit 40. FIG. 4 shows a cross section of the rotating body support unit 40 taken along a plane containing the center of rotation of the rotating body/bodies (i.e., crankshaft 41 and rotational component 42). In the example embodiment shown in FIG. 4, the housing 2 includes two housing portions 2A and 2B. The space defined by the two housing portions 2A and 2B represents the space within the housing 2. The housing 2 holds a motor 30, the crankshaft 41, the rotational component 42, and at least one transmission gear 32, 33. The transmission gears 32 and 33 define a decelerating mechanism that decelerates the rotation of the motor 30. In the example embodiment of FIG. 4, the decelerating mechanism includes two transmission gears 32 and 33. The decelerating mechanism may also include only one transmission gear. In some example embodiments, the rotating body support unit 40 may be configured such that at least one of the motor 30 or decelerating mechanism is omitted.

The rotating body support unit 40 includes the crankshaft 41 and rotational component 42 that correspond to the rotating bodies. The rotational component 42 includes a first rotational component portion 421 and a second rotational component portion 422. A one-way clutch 43 is provided between the first and second rotational component portions 421 and 422. The second rotational component portion 422 rotates together with the crankshaft 41. Specifically, the second rotational component portion 422 rotates together with the crankshaft regardless of whether the crankshaft 41 is rotating in a forward direction or in a rearward direction. The one-way clutch 43 transmits rotation in the forward direction and does not transmit rotation in the rearward direction. The first rotational component portion 421 rotates together with the crankshaft 41 when the crankshaft 41 is rotating in the forward direction, and does not rotate together with the crankshaft when the crankshaft 41 is rotating in the rearward direction. Rotation in the forward direction is rotation that causes the bicycle to travel forward, while rotation in the rearward direction is rotation in the opposite direction.

A torque sensor 44 is provided on the outer circumference of the second rotational component portion 422. The torque sensor 44 detects a pedaling force by detecting a torque that rotates the crankshaft 41 about its axis. The torque sensor 44 may be, for example, a non-contact torque sensor such as a magnetostrictive sensor, or a contact torque sensor such as an elastic-body variable detection-type sensor. A magnetostrictive torque sensor includes a magnetostrictive member that produces magnetostrictive effects and that receives a rotational force of the crankshaft, and a detection coil that detects a change in magnetic permeability caused by a force from the magnetostrictive member. In some example embodiments, the torque sensor 44 may be omitted. In other example embodiments, the rotating body support unit may include a crankshaft rotation sensor that detects rotation of the crankshaft, or a substrate on which a control device is mounted, or other parts.

The rotational component 42 may include a driven gear 4211 to which rotation of the motor is transmitted. The driven gear 4211 may engage with the transmission gear 33, for example. A one-way clutch may be provided on the transmission path from the motor 30 to the driven gear 4211. Further, in the example embodiment of FIG. 4, a first sprocket 45 is mounted on a portion of the rotational component 42 located outside the housing 2.

In the example embodiment of FIG. 4, a first bearing 4a and a second bearing 4b are provided on the rotating bodies corresponding to the crankshaft 41 and rotational component 42. In other words, the bearings 4 include first and second bearings 4a and 4b. The first and second bearings 4a and 4b are spaced apart in the axial direction of the rotating body/bodies. The rotating body support unit 40 includes a first case 3a that supports the first bearing 4a, and a second case 3b that supports the second bearing 4b. In other words, the cases 3 include first and second cases 3a and 3b. The first case 3a is mountable on and detachable from one side of the housing 2 as determined along the axial direction of the rotating body/bodes (in the example embodiment of FIG. 4, from the right). The second case 3b is mountable on and detachable from another side of the housing 2 as determined along the axial direction of the rotating body/bodies (in the example embodiment of FIG. 4, from the left). The first case 3a supports a portion of the relevant rotating body spaced apart from its center along its axial direction toward one end thereof, and the second case 3b supports a portion of the relevant rotating body spaced apart from its center along its axial direction toward the other end thereof.

In the example embodiment of FIG. 4, the first bearing 4a supports the rotational component 42, and the second bearing 4b supports the crankshaft 41. In such example embodiments, the crankshaft 41 and rotational component 42 extend through the first case 3a, whereas the crankshaft 41 extends through the second case 3b. In a variation, both the first and second bearings 4a and 4b may be configured to support the crankshaft 41 or rotational component 42.

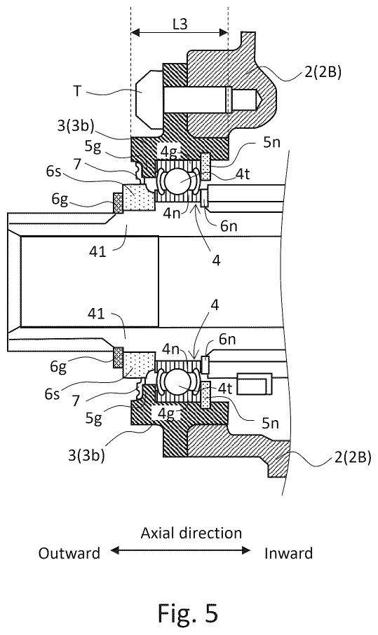

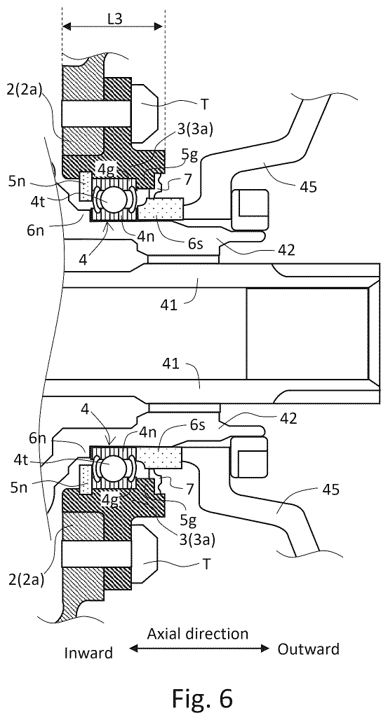

FIG. 5 is an enlarged view of the second bearing 4b and surrounding areas of FIG. 4. FIG. 6 is an enlarged view of the first bearing 4a and surrounding areas of FIG. 4. Each bearing 4 includes an outer ring 4g, an inner ring 4n, and rollers 4t. The outer ring 4g is mounted on the associated case 3. The inner ring 4n is mounted on the relevant rotating body (i.e., crankshaft 41 or rotational component 42). The outer ring 4g of the bearing 4 is mounted on the case 3. The inner ring 4n of each bearing 4 may be clearance fitted or transition mounted on the relevant rotating body (i.e., crankshaft 41 or rotational component 42). This further facilitates removal of the bearing 4, together with the case 3, from the housing.

In the example embodiment of FIGS. 5 and 6, for each bearing 4, an inner-ring support 6s is provided to support the outer surface, along the axial direction, of the inner ring 4n. Further, an inner inner-ring retainer 6n is provided to support the inner surface, along the axial direction, of the inner ring 4n of the bearing 4. By way of example, the inner inner-ring retainer 6n corresponds to a retaining ring (i.e., circlip) mounted on a groove on the outer circumferential surface of the relevant rotating body (i.e., crankshaft 41).

In the example embodiment of FIG. 5, an outer inner-ring retainer 6g is further provided to support the outer surface, along the axial direction, of the inner ring of the bearing 4. In the example embodiment of FIG. 5, by way of example, the outer inner-ring retainer 6g corresponds to a retaining ring (i.e., circlip) mounted on a groove on the outer circumferential surface of the relevant rotating body (i.e., crankshaft 41). The inner-ring support 6s is positioned between the outer inner-ring retainer 6g and inner ring 4n to serve as a spacer.

In the example embodiment of FIG. 6, the inner-ring support 6s is positioned between the first sprocket 45 and inner ring 4n to serve as a spacer. The first sprocket 45 is mounted on the rotational component 42 so as not to slip off in the axial direction. Thus, the inner-ring support 6s functions as a retainer located outward of the inner ring 4n along the axial direction.

In the example embodiment of FIGS. 5 and 6, for each bearing 4, a seal 7 is provided outward of the bearing along the axial direction to seal the gap between the relevant case 3 and inner-ring support 6s. The seal 7 may be elastic body. The seal 7 may be made from, for example, a synthetic rubber, a metal, or a combination thereof. The seal 7 contacts the inner circumferential surface of the case 3 and the outer circumferential surface of the inner-ring support 6s. In this example embodiment, the seal 7 is mounted on the case 3 and fixed thereto, and configured to be slidable on the inner-ring support 6s. In such example embodiments, when the case 3 with the bearing 4 and seal 7 mounted thereon is moved relative to the housing 2 from the outside toward the inside along the axial direction, the seal 7 slides on the associated rotating body. This enables positioning the seal 7 while preventing the lip of the seal 7 from facing axially inwardly.

In the example embodiment of FIGS. 5 and 6 are provided, for each bearing 4, an inner outer-ring retainer 5n that supports the inner surface, along the axial direction, of the outer ring of the bearing and an outer outer-ring retainer 5g that supports the outer surface, along the axial direction, of the bearing 4. By way of example, the inner outer-ring retainer 5n corresponds to a retaining ring (i.e., circlip) mounted on a groove on the inner circumferential surface of the relevant case 3. The outer outer-ring retainer 5g may be a projection on the inner circumferential surface of a tubular portion of the case 3. The projection protrudes radially inwardly from the tubular portion. The projection may be provided, for example, on at least a portion of the circumference of the inner circumferential surface of the tubular portion. Alternatively, the outer outer-ring retainer 5g may be a projection on the inner circumferential surface of the housing 2.

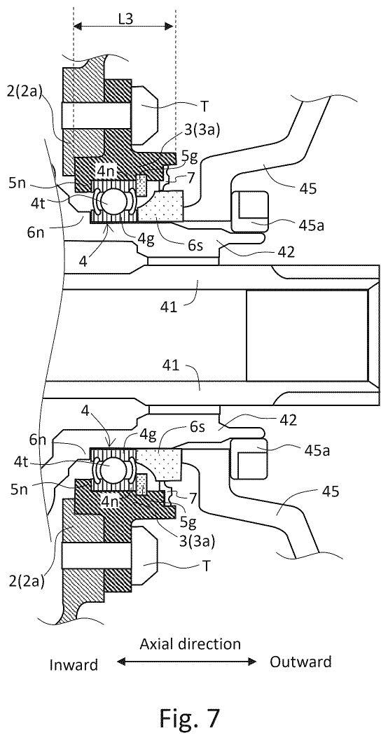

In a variation, as shown in FIG. 7, the inner outer-ring retainer 5n may be a projection on the case 3 and the outer outer-ring retainer 5g may be a retaining ring.

A case 3 and the housing 2 may include a position-fixing structure that fixes the case 3 in position relative to the housing 2. The position-fixing structure may be, for example, a structure that fixes the case 3 in the circumferential position with respect to the associated rotating body relative to the housing 2. For example, a position-fixing projection is provided on a portion of one of the contact surface of the housing 2 with the case 3 and the contact surface of the case 3 with the housing 2, and a recess is provided on the other one. The position-fixing projection and position-fixing recess are shaped to snugly fit together.

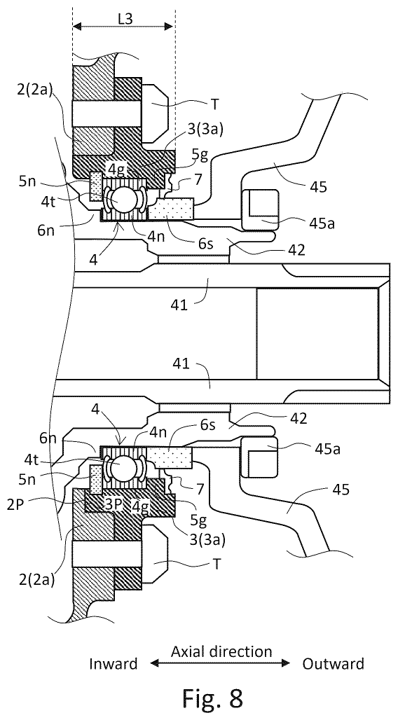

FIG. 8 is a cross-sectional view of an example embodiment starting from FIG. 6, where a position-fixing structure is added. In the example embodiment of FIG. 8 are provided a radially recessed position-fixing recess 2P on a portion of the inner circumferential surface of the case 3, and a radially protruding position-fixing projection 3P on a portion of the outer circumferential surface of the housing 2. This allows the case 3 to be fixed in the circumferential position with respect to the associated rotating body relative to the housing 2. It is to be noted that the position-fixing structure is not limited to such an example embodiment. For example, a pin provided on one of the case 3 and housing 2 to extend in the axial direction and a hole provided on the other one may correspond to a position-fixing projection and a position-fixing recess.

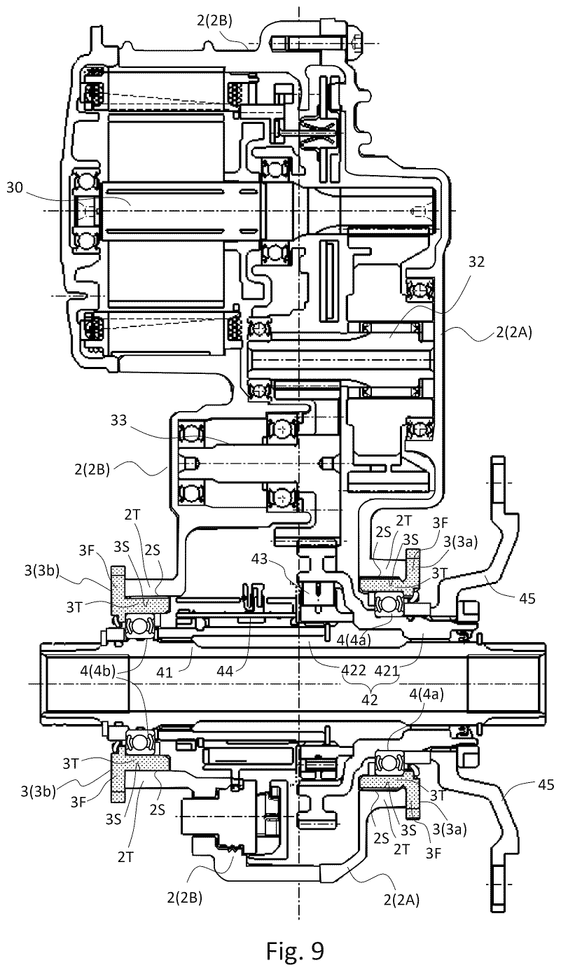

FIG. 9 is a cross-sectional view of a variation of the rotating body support unit 40. In the example embodiment of FIG. 9, each case 3 is mounted on the housing 2 by joining a thread 3S on the case 3 and a thread 2S on the housing 2. The thread 3S is one example of a first thread, while the thread 2S is one example of a second thread. The case 3 includes a tubular portion 3T coaxial with the associated rotating body (i.e., crankshaft 41). The housing 2 includes a tubular housing portion 2T coaxial with the rotating body. The tubular portion 2T of the housing is shaped to correspond to the tubular portion 3T of the case 3. By way of example, the tubular portion 3T of the case 3 is configured to be inserted into the tubular portion 2T of the housing. In such example embodiments, the male thread 3S is formed on the outer circumference of the tubular portion 3T of the case 3. The female thread 2S is provided on the inner circumference of the tubular portion 2T of the housing. The male thread 3S on the tubular portion 3T of the case 3 and the female thread 2S on the tubular portion 2T of the housing are joined.

By way of example, the tubular portion 3T of the case 3 includes a flange 3F radially protruding from the thread 2S of the case 3. The flange 3F supports the end surface, along the axial direction, of the tubular portion 2T of the housing. This allows the case 3 and housing 2 to be fixed in the axial position.

The example embodiment of FIG. 9 is an arrangement where a male thread on a case 3 and a female thread on the housing 2 are joined. In a variation, a female thread on a case 3 and a male thread on the housing 2 may be joined. In such example embodiments, for example, the tubular portion of the case and the tubular portion of the housing are configured such that the latter is introducible into the former. A female thread is formed on the inner circumference of the tubular portion of the case, while a male thread is provided on the outer circumference of the tubular portion of the housing.

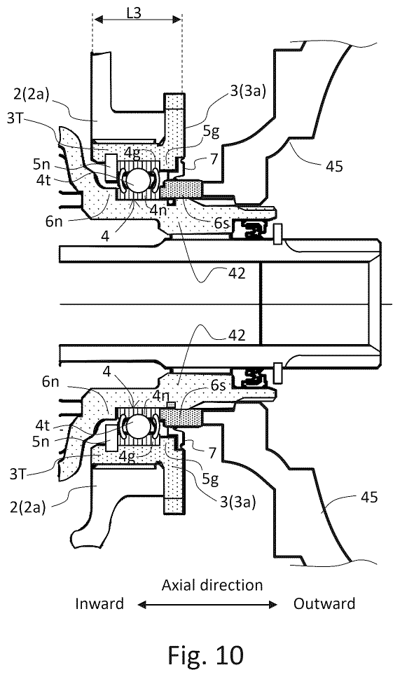

FIG. 10 is an enlarged view of the bearing 4 and surrounding areas of FIG. 9. As shown in FIG. 10, in this example embodiment are also provided an inner outer-ring retainer 5n, an outer outer-ring retainer 5g, an inner inner-ring retainer 6n, an inner-ring support 6s, and a seal 7. In the example embodiment of FIG. 10, the inner outer-ring retainer 5n and the outer outer-ring retainer 5g are located on the inner circumference of the tubular portion 3T of the case 3. The seal 7 is mounted on the inner circumference of the tubular portion 3T of the case 3 and fixed thereto, and is slidable on the inner-ring support 6s. The lip of the seal 7 contacts the inner-ring support 6s. This arrangement enables removing the case 3, with the bearing 4 fitted therein, from the housing 2, replacing the bearing 4, mounting the case 3 on the housing 2 again, and then mounting the seal 7 on the case 3. The seal 7 may thus be replaced.

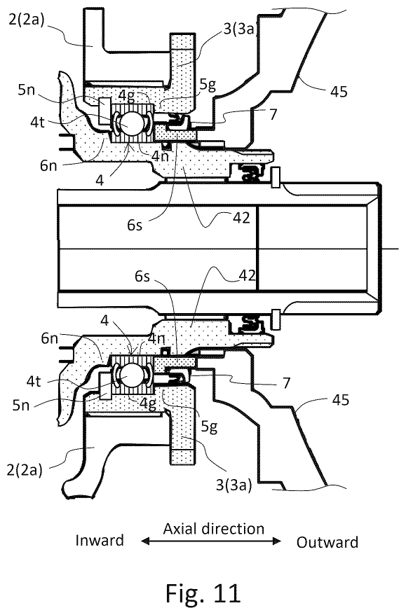

FIG. 11 is a cross-sectional view showing a variation of the seal 7. In the example embodiment of FIG. 11, the seal 7 is mounted on the inner-ring support 6s and fixed thereto, and configured to be slidable on the case 3. The lip of the seal 7 contacts the case 3. In such example embodiments, after the case 3 is mounted on the housing 2, the inner-ring support 6s, with the seal 7 mounted thereon, may be mounted on the associated rotating body (in this example embodiment, the rotational component 42). During this mounting, the lip of the seal 7, while being pressed against the case 3, moves axially inwardly. Thus, the lip of the seal 7 contacts the case 3 as its tip does not face radially inwardly and extends outwardly. This enables positioning the seal 7 in an appropriate state.

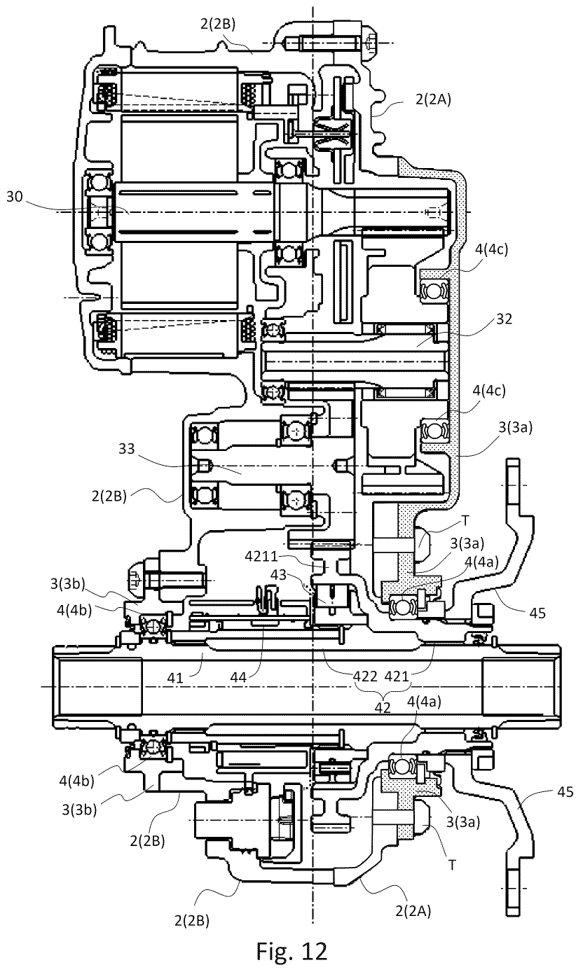

FIG. 12 is a cross-sectional view of a variation of the rotating body support unit 40. In a variation, one case may be configured to support a plurality of bearings. In the example embodiment of FIG. 12, the first case 3a is configured to support the bearing 4a and a bearing 4c. The bearing 4a supports the rotational component 42, which is coaxial with the crankshaft 41. The bearing 4c supports the transmission gear 32. Thus, one case may include a plurality of tubular portions that allow a plurality of bearings to be respectively positioned therein, and a coupling portion that couples these tubular portions. The plurality of tubular portions and the coupling portion may be unitary, or may be made integral by joining separate parts. Each of the tubular portions supports a rotational component. At least one of the tubular portions is configured to allow a rotating body to extend therethrough. The combination of rotating bodies supported by one case is not limited to the rotational component 42 and the transmission gear of the example embodiment shown in FIG. 12. For example, at least two of the crankshaft, rotational components, transmission gears, and motor may be supported by bearings of a single case.

In example embodiments described above, the axial dimension L3 of a case 3 of the rotating body support unit 40 is longer than the axial dimension of a bearing 4 (see FIGS. 5, 6, 7, 8, and 10). In the example embodiments of FIGS. 2 to 11, a case 3 is a tubular body, where the entire case 3 corresponds to a tubular body. Further, the axial dimension of the tubular body of a case 3 is longer than the axial dimension of a bearing 4. Thus, for example, an entire bearing 4 may be positioned inside the tubular portion of a case 3. Further, both an inner outer-ring retainer and the associated outer outer-ring retainer may be positioned inside the tubular body of a case 3.

The present invention is not limited to the above-described example embodiments. In the above-described example embodiments, the rotating body support unit includes a motor and a torque sensor. At least one of the motor or torque sensor may be omitted. For example, the rotating body support unit may be configured to include no motor but include a torque sensor that detects the torque of the rotation of a rotating body, i.e., crankshaft.

Furthermore, in the above-described example embodiments, the crankshaft 41 and rotational component 42, corresponding to the rotating bodies, are supported by a case via a bearing. In a variation, only one of the crankshaft 41 or rotational component 42 may be a rotating body supported by the case. Alternatively, for example, the output shaft of the motor or a transmission gear may be a rotating body supported by a case.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotating body support unit mountable on a frame of a bicycle, the rotating body support unit comprising:
a housing mountable on the frame;
a rotating body at least partially located within the housing;
a bearing to rotatably support the rotating body; and
a case detachably mounted to an outside of the housing along an axial direction of the rotating body to support the bearing; wherein
the bearing includes an outer ring, an inner ring, and rollers between the outer ring and the inner ring;
the outer ring is mounted on the case and the inner ring is mounted on the rotating body; and
the rotating body is a crankshaft of the bicycle or a rotational component with a same center of rotation as the crankshaft.

2. The rotating body support unit according to claim 1, further comprising a fastener to mount the case to the housing.

3. The rotating body support unit according to claim 2, wherein the case and the housing include a position-fixing structure to fix the case in position relative to the housing.

4. The rotating body support unit according to claim 1, wherein the case includes a first thread, the housing includes a second thread, and the case is threadedly mounted to the housing by the first thread and the second thread.

5. The rotating body support unit according to claim 1, wherein the outer ring of the bearing is press-fitted on the case.

6. The rotating body support unit according to claim 1, wherein
the bearing includes a first bearing and a second bearing spaced apart in the axial direction of the rotating body; and
the case includes a first case to support the first bearing and mountable to and detachable from a first side of the housing along the axial direction of the rotating body, and a second case to support the second bearing and mountable to and detachable from a second side of the housing along the axial direction of the rotating body.

7. The rotating body support unit according to claim 1, further comprising:
an outer-ring retainer to support an axial inner surface or an axial outer surface of the outer ring of the bearing; wherein
the outer-ring retainer is integral or unitary with the case or the housing.

8. The rotating body support unit according to claim 1, further comprising:
an inner-ring support to support an axial outer surface of the inner ring of the bearing and being mounted on the rotating body.

9. The rotating body support unit according to claim 8, further comprising:
a seal located axially outward of the bearing to seal a gap between the case and the inner-ring support.

10. The rotating body support unit according to claim 1, wherein an axial dimension of the case is longer than an axial dimension of the bearing.

11. A bicycle comprising:
the rotating body support unit according to claim 1.

12. The bicycle according to claim 11, further comprising:
the frame;
a vehicle wheel rotatably supported by the frame; and
a transmission to transmit a driving force from the crankshaft to the vehicle wheel.
